(19) United States
(12) Patent Application Publication
(10) Pub. No.: US 2011/0050511 A1
(43) Pub. Date: Mar. 3, 2011

(54) DEVICE HOUSING

(75) Inventor: QIANG WANG, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/766,211

(22) Filed: Apr. 23, 2010

(30) Foreign Application Priority Data
Sep. 3, 2009 (CN) 200910306548.8

(51) Int. Cl. H01Q 1/24

(52) U.S. Cl. 343/702

(57) ABSTRACT

A device housing comprises a main body and an three-dimensional antenna formed on the main body. The main body is made of non-conductive plastic. The three-dimensional antenna is made of conductive plastic. The main body and the three-dimensional antenna are formed by a two-shot injection molding process.

### BACKGROUND

1. Technical Field

The present disclosure relates to device housings, especially to a device housing having a three-dimensional antenna formed thereon.

2. Description of Related Art

Antennas are critical for wireless communication of electronic devices. The antenna may be a thin metal piece mounted to a support member, and attached to a device's housing. To save space, weight, and money, the antenna may be directly attached to the housing without the support member. However, the antenna, especially the three-dimensional antenna mounted without a support member is prone to be damaged during manufacturing. To solve this problem, a printable antenna is used by printing conductive ink coatings on the housings. However, the conductive ink coatings can be difficult to print on the housings especially when trying to form three-dimensional antennas, which perform better in some applications than two-dimensional antennas.

Therefore, there is room for improvement within the art.

### BRIEF DESCRIPTION OF THE FIGURES

Many aspects of the device housing can be better understood with reference to the following figures. The components in the figures are not necessarily drawn to scale, the emphasis instead being placed upon clearly illustrating the principles of the device housing. Moreover, in the drawings like reference numerals designate corresponding parts throughout the several views.

FIG. 1 is a schematic view of an exemplary embodiment of a device housing.

FIG. 2 is an exploded view of an exemplary embodiment of a device housing shown in FIG. 1.

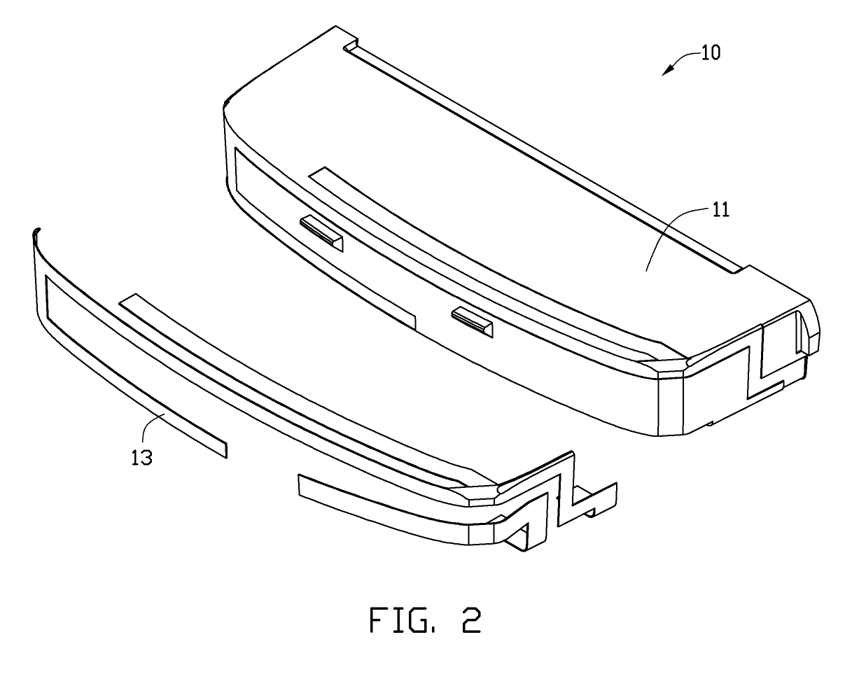

### DETAILED DESCRIPTION

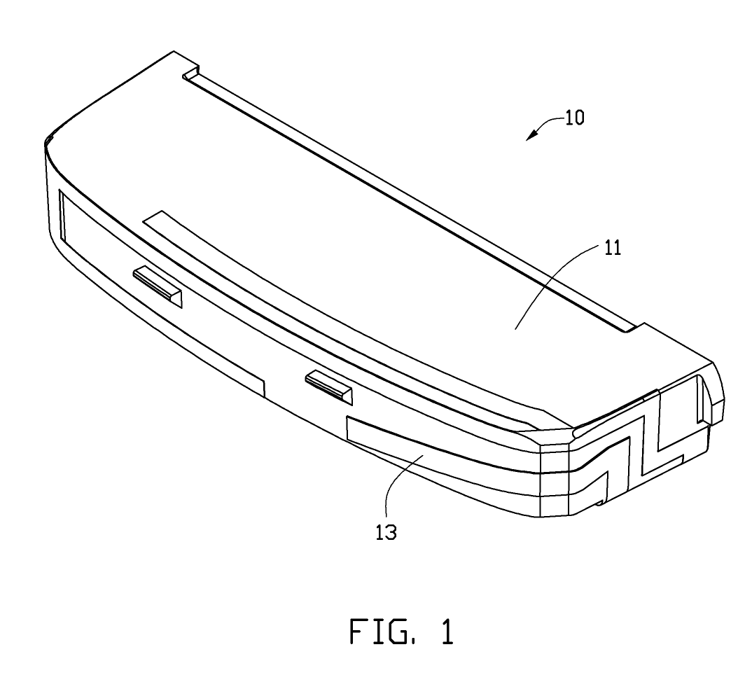

FIG. 1 shows a device housing 10 including a main body 11 and a three-dimensional antenna 13 formed on the main body 11. By three-dimensional, it is meant that the antenna is not confined to one plane in shape. The main body 11 and the three-dimensional antenna 13 are formed by a two-shot injection molding process.

The main body 11 may be molded with non-conductive plastics. The non-conductive plastics may be one or more materials selected from a group consisting of polypropylene (PP), polyamide (PA), polycarbonate (PC), polyethylene terephthalate (PET), and polymethyl methacrylate (PMMA).

The three-dimensional antenna 13 may be molded directly on the main body 11 using conductive plastic. The three-dimensional antenna 13 may define electrical contacts thereon (not shown in the figure).

The conductive plastics for forming the three-dimensional antenna 13 may be conductive fiber enhancing plastics. The conductive fiber enhancing plastic is manufactured from thermoplastic material composed of conductive fibers.

The thermoplastic material may be selected from a group consisting of polypropylene (PP), polyamide (PA), polycarbonate (PC), polyethylene terephthalate (PET), polymethyl methacrylate (PMMA), polyphenylene oxide (PPO), and polyphenylene sulfide (PPS).

The conductive fiber may be selected from a group consisting of metal fiber, carbon fiber, metallic carbon fiber, metallic glass fiber, metallic boron fiber, and metallic silicon carbide. The conductive fiber can also be a composite of several of the exemplary fibers.

The metal fiber may be stainless steel fiber, copper fiber, aluminum fiber, nickel fiber, metal alloy fiber, metallic oxide fiber, or a composite of several of the exemplary metal fibers.

Additive agents may be added into the conductive plastic. The additive agents may be plasticizer, surface treating agent, fire retardant, light stabilizer, and antioxidant.

The conductive plastic can also be an eigenstate conductive polymer, such as conductive polyaniline (PAN), conductive polypyrrole (PPY), conductive polythiophene (PTH), or conductive poly p-phenelene vinylene (PPV).

A transparent protective coating can be formed on the main body and the three-dimensional antenna 13 to protect the main body 11 and the antenna 13 from abrasion. The protective coating can be a paint coating.

The three-dimensional antenna 13 can be designed with many suitable shapes according to frequencies to be used while at the same time be form fitting with the housing thereby being supported by the housing and protected from breakage during manufacturing, and the three-dimensional antenna 13 can be easily produced/molded and highly yielded.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A device housing, comprising:
a main body made of non-conductive plastic; and
a three-dimensional antenna made of conductive plastic and formed on the main body;
wherein the main body and the three-dimensional antenna are formed by a two-shot injection molding process.

2. The device housing as claimed in claim 1, wherein the non-conductive plastic is one or more materials selected from a group consisting of polypropylene, polyamide, polycarbonate, polyethylene terephthalate, and polymethyl methacrylate.

3. The device housing as claimed in claim 1, wherein the conductive plastic is conductive fiber enhancing plastic or eigenstate conductive polymer.

4. The device housing as claimed in claim 3, wherein the conductive fiber enhancing plastic is manufactured from thermoplastic materials composed of conductive fibers.

5. The device housing as claimed in claim 4, wherein the thermoplastic material is selected from a group consisting of polypropylene, polyamide, polycarbonate, polyethylene terephthalate, polymethyl methacrylate, polyphenylene oxide, and polyphenylene sulfide.

6. The device housing as claimed in claim 4, wherein the conductive fiber is metal fiber, carbon fiber, metallic carbon fiber, metallic glass fiber, metallic boron fiber, metallic silicon carbide, or a composite of several of the exemplary conductive fibers.

7. The device housing as claimed in claim 6, wherein the metal fiber is stainless steel fiber, copper fiber, alumina fiber, nickel fiber, metal alloy fiber, conductive metallic oxide fiber, or a composite of several of the exemplary metal fibers.

8. The device housing as claimed in claim 3, wherein the eigenstate conductive polymer is conductive polyaniline, conductive polypyrrole, conductive polythiophene, or conductive poly p-phenelene vinylene.

9. The device housing as claimed in claim 6, wherein the conductive plastic further contains plasticizer, surface treating agent, fire retardant, light stabilizer, and antioxidant.

10. The device housing as claimed in claim 1, further comprising a transparent protective coating formed on the main body and the three-dimensional antenna.

11. The device housing as claimed in claim 10, wherein the protective coating is a paint coating.
